(19) United States
(12) Patent Application Publication
(10) Pub. No.: US 2012/0070544 A1
(43) Pub. Date: Mar. 22, 2012

(54) PAD FOR PREPARING A BEVERAGE, A CONTAINER COMPRISING SEVERAL PADS, AN APPARATUS AND A METHOD FOR PREPARING THE BEVERAGE

(75) Inventors: Jos Christiaan Van der Veen, Nieuwegein (NL); Thomas Hoekstra, Utrecht (NL); Arend Cornelis Jacobus Biesheuvel, Werkendam (NL)

(73) Assignee: Sara Lee/DE B.V

(21) Appl. No.: 13/281,121

(22) Filed: Oct. 25, 2011

Related U.S. Application Data
(63) Continuation of application No. PCT/NL2010/050243, filed on Apr. 27, 2010.

(30) Foreign Application Priority Data
Apr. 27, 2009 (NL) NL2002810

(51) Int. Cl. B65B 29/02; A23L 2/38; B65B 1/04; A47J 31/46

(52) U.S. Cl. 426/78; 426/77; 426/84; 99/289 R; 426/431; 53/473

(57) ABSTRACT

The invention relates to a pad comprising an extractable product for preparing a beverage suitable for consumption. The pad is provided with a first covering, a second covering attached to the first covering, and an inner chamber formed between the first and second covering for accommodating the extractable product. The pad is received in an apparatus arranged for preparing the beverage for intercepting a flow of fluid having supra-atmospheric pressure. The first covering conducts the fluid into the inner chamber for interacting with the extractable product for preparing the beverage and the second covering is conceived to conduct the beverage away from the inner chamber. The first covering comprises a partially transparent material for enabling visual inspection of the extractable product. The invention further relates to an apparatus, a container, a method of preparing a beverage and a method of manufacturing a pad.

### CROSS REFERENCE TO RELATED APPLICATIONS

The present application is a continuation application of International Patent Application Serial No. PCT/NL2010/050243 filed on Apr. 27, 2010; which claimed priority to The Netherlands Application No. NL2002810 filed on Apr. 27, 2009. Both applications are hereby incorporated herein by reference in their entireties.

### FIELD

The invention relates to a pad comprising an extractable product for preparing a beverage suitable for consumption, said pad provided with a first covering, a second covering attached to the first covering, an inner chamber formed between the first covering and the second covering for accommodating the extractable product, wherein the pad is conceived to be received in an apparatus arranged for preparing the beverage for intercepting a flow of fluid having supra-atmospheric pressure, wherein the first covering is conceived to conduct the fluid into the inner chamber for interacting with the extractable product for preparing the beverage and the second covering is conceived conduct the beverage away from the inner chamber.

The invention further relates to a container comprising a pad.

The invention still further relates to an apparatus and a method for preparing a beverage.

The invention still further relates to a method of manufacturing a pad comprising an extractable product.

### BACKGROUND

An embodiment of a pad as is set forth in the opening paragraph is known from US 2007/0071869. The known pad comprises ground coffee accommodated in an inner chamber formed by an upper sheet and a lower sheet both made of a conventional filter paper. The upper sheet of the filter paper is attached to the lower sheet of the filter paper along a circumferential line running substantially along a perimeter of the pad. The upper and the lower sheets are sealed together for forming a substantially hermetical sealing joint.

It is a disadvantage of the known pad that the filter paper of the outer layers substantially obstructs inspection of the inner chamber accommodating the extractable product. This may lead to decreased user satisfaction, especially when preparing a beverage from a natural high quality product, such as ground coffee. More in particular, the user may adversely perceive the known pad as an item comprising an artificial or manipulated product leading to a decreased willingness to use such pads and/or to a decreased satisfaction during preparing a beverage, such as coffee, using such pads.

### SUMMARY

It is an object of the invention to provide an improved pad for preparing a beverage suitable for consumption, such as coffee. It is a further object of the invention to provide an alternative pad for preparing a beverage suitable for consumption, such as coffee.

To this end in the pad according to the invention comprises an extractable product for preparing a beverage suitable for consumption, said pad is provided with a first covering, a second covering attached to the first covering, an inner chamber formed between the first covering and the second covering for accommodating the extractable product, wherein the pad is conceived to be received in an apparatus arranged for preparing the beverage for intercepting a flow of fluid having supra-atmospheric pressure, wherein the first covering is conceived to conduct the fluid into the inner chamber for interacting with the extractable product for preparing the beverage and the second covering is conceived to conduct the beverage away from the inner chamber, said first covering comprising a partially transparent material for enabling visual inspection of the extractable product.

Preferably, the partially transparent material has at least 40% transparency to visible light. It will be appreciated that the term ‘partially transparent’ should be understood as a degree of transparency sufficient for enabling visual inspection of the extractable product accommodated in the inner chamber. It will further be appreciated that known pads made of filter paper do not enable visual inspection of the extractable product. More preferably, the partially transparent material is at least 50%, 70% transparent to visible light, or even at least 90% transparent. However, it is also possible that 10%, 20%, 30% or 40% transparency is sufficient for enabling visual inspection of the extractable product accommodated in the pad. Such pad having increased transparency is advantageous as it allows visual inspection of the accommodated product, which may improve user friendliness of the pad as a whole.

It will be further appreciated that transparency may be expressed as a characteristic of a light beam transversed a sample (i.e. the first covering) and being given by the following expression:

j=w−s,
wherein j is transparency;
w is a reflection coefficient of the sample when a white plate is provided underneath the sample;
s is a reflection coefficient of the sample when a black plate is provided under the sample.

Preferable w and s are measured in narrow bundle geometry for a source of white light, a beam spot having less than 1 cm² in cross-section. Further details on an experiment for measuring transparency are discussed with reference to FIG. 8.

In a further advantageous embodiment, the first covering may have a different transparency than the second covering. For example, the first covering may have 10% higher transparency than the second covering. Alternatively, the first covering may have 20%, 30%, 40%, 50%, 70%, 80% or 90% higher transparency than the second covering.

The partially transparent material may relate to a mesh, preferably a nylon mesh. It is found to be advantageous to use a mesh-like material for the first covering, as such material enables the user to visually perceive the extractable product before use and because mesh is relatively cheap is production.

Alternatively, the partially transparent material may relate to a fiber-based or continuous filament based non-woven material.

It is found that a fiber-based non-woven material, such as, for example, known from EP 0 766 755, provides an improved material for forming at least the first covering of the pad. It will be appreciated that the first covering is usually located on the upper surface of the pad, that is, the surface which is observed by the user during handling of the pad and during installing the pad in the apparatus for preparing the beverage.

Due to the fact the fiber-based materials, such as materials comprising lyocell fibers are substantially transparent, the user has an opportunity to inspect the inner chamber of the pad and to ensure himself that the beverage he is about to prepare is made from a quality product. In addition, by doing so, the user is capable of visually inspecting whether the initial high quality product has not deteriorated.

It is possible that the material of the second covering is different than the material of the first covering. For example, a conventional filter paper may be used for the second covering. Alternatively, it is possible that the fiber material used for the first covering is the same in structure, chemical composition and thickness as the material used for the second covering. However, it is found to be advantageous to select a thicker material for the second covering than the material used for the first covering, as the second covering is supposed to be deformed to a higher extend in use than the first covering due to operation particulars of a conventional apparatus for preparing the beverage.

In general, the pad is conceived to accommodate ground coffee and to be positioned in a conventional coffee apparatus, which may be operable using a suitable fluid provided with a pressure between 1 and 20 bars, preferably between 1 and 2 bars. It will also be appreciated that the apparatus may be arranged to provide the fluid with a pressure about 1 bar or exactly 1 bar. However, it will be appreciated that other extracts, like tea, chocolate, or mixtures, like cream coffee, cappuccino, etc., may be prepared using the pad of the invention as well.

In a particular embodiment of the pad according to the invention thickness of the first covering is about 18 g/m2 and thickness of the second covering is about 30 g/m2.

It is further found that when the pad is provided from fiber-based non-woven material it provides an improved compartment for storing coffee than the pad known from the art, as in the pad according to the invention ground coffee stays longer in a substantially fresh condition, compared to a pad formed from a filter paper. This may at least partially be explained by the fact that the fibers of the fiber-based non-woven material absorb less oil from the ground coffee which leads to reduced oxidation of coffee stored in such pad.

In a further embodiment of the pad according to the invention the fiber-based non-woven material comprises two-component (bicomponent) fibers having a first component arranged in a core region of the fiber and a second component arranged in a shell about said core region.

It is found that two-component fibers may be mechanically stronger than conventional fibers, like lyocell. In addition, by purposefully selecting materials of the two-component fibers properties of the pad may further be improved, in particular properties relating to preserving the extractable product accommodated in the pad.

It is found that when the first component of the two-component fiber is polyester and when the second component of the two-component fiber is polyethylene, oil absorption of such fibers is further reduced. Because a speed of degrading of taste properties of coffee correlates with amount of oil absorbed in the pad material, such substantially non-absorbing two-component fiber material is advantageous.

It is found that such fibers with increased cross-section may be advantageous as such pad may have improved properties regarding form retention. It will be appreciated, however, that the pad according to the invention may suitably relate to a pellet-shaped, substantially flat and flexible item. However, for some applications, for example for pads having one or more inner chambers, the lower portion of the pad may be pre-shaped. For example, the lower portion of the pad may be cup-shaped. In this case, the lower covering provided from a fiber-based material having increased fiber cross-section may be advantageous.

In a still further embodiment of the pad according to the invention the fiber-based non-woven material comprises about 20% of cellulose.

For example, a suitable fiber-based material may comprise about 20% cellulose and about 80% of a synthetic material. In general, it will be appreciated that instead of cellulose other materials may be used, such as pig hair, polyethylene, straw, nettle, flax, sisal or the like.

In a still further embodiment of the pad according to the invention, the fibers of the fiber-based non-woven material are non-bleached.

It is found that by inducing a particular appearance to the fibers, perception of the pad as a whole by the user may be improved. For example, it is possible to adjust color, gloss or opacity to the fibers and thereby improve overall perception of the pad. In particular, color adjustment of the pad may be achieved by avoiding a bleaching step during manufacturing of a suitable fiber-based material. As a result the pad may be of a slight yellow or a slight brown color, which is usually associated with natural products. In addition, by avoiding bleaching step adverse environmental effects are avoided.

In a still further embodiment of the pad according to the invention the first covering and/or the second covering comprise an additive for altering a chemical property of the fluid or the beverage.

It is found to be particularly advantageous to use the pad for improving chemical properties of the fluid, such as water, or the beverage, such as coffee. For, example, it is possible to provide suitable chemical additives on a surface of the at least the first covering for modifying any one of the following—a taste, pH, or hydrophobic properties of the pad material itself. In order to suitably modify and/or to improve taste of the resulting beverage, the first and/or the second covering may comprise dried coffee extracts, sugar, further aroma's, or additives, like a liquor. In order to modify pH the first and/or the second covering may comprise a suitable base or acid, depending on the geographic area the pad is to be marketed. As a result, the taste of the prepared beverage does not deteriorate when quality of water changes upon arrival at different location. Such property may be particularly advantageous for restaurants, café's or other establishments distributed over different geographic areas.

In a still further embodiment of the pad according to the invention an outer surface of at least one of the first covering and the second covering comprises a pre-determined height profile.

It is found that when the height profile of at least one of the coverings of the pad has a periodic pattern, such surface may be perceived as extremely soft, which improves user satisfaction when handling the pad.

In a still further embodiment of the pad according to the invention, material of at least one of the first covering and the second covering comprises an area capable of transporting microscopic amounts of the extractable product outside the inner chamber before use.

It is found that it may be advantageous to arrange the pad to be not fully hermetic to the extractable product. In particular, when the extractable product is ground coffee, it may be advantageous that minor, microscopic corpuscles of ground coffee may escape the pad upon storage. As a result a pleasant odour will be generated in an area about the pad. More in particular, when the pads are conceived to be stored in a hermetic container, the user may instantly enjoy the extractable product, such as coffee, upon handling the pads. In addition, the user may be set in a particular condition of enjoyment, as he is assured that the beverage he is about to prepare is made of a natural high quality extractable product, such as coffee or tea.

In a still further embodiment of the pad according to the invention the said material comprises micro-pores substantially homogeneously distributed over a surface area of the material.

Although it is possible to provide the material of the first opening and/or the second opening to comprise a pre-determined area emitting microscopic amounts of the extractable product before use, it is advantageous to provide the material of the first covering and/or the second covering with suitable pores distributed substantially homogeneously over the surface area of the first covering and/or the second covering. For example, a technological step of preparing the fiber-based non-woven material may be suitably adapted for reducing density of such material. As a result inherent micro-pores may be provided emitting corpuscles of the extractable product.

In a still further embodiment of the pad according to the invention at least one of the first covering and the second covering is biodegradable.

It is found to be advantageous to provide a biodegradable pad, as such pad may be readily utilized. For example, the first covering and/or the second covering may be at least partially manufactured from a renewable resource, like polyethylene obtained from corn. As a result a pad is provided which meets environmental requirements for a fully biologic product.

According to a further aspect of the invention, a pad is provided comprising a first covering and a second covering, as is described with reference to the foregoing, wherein the first covering comprises pre-manufactured openings provided in a region conceived to intercept the fluid in use.

It is found to be advantageous to provide a suitable set of microscopic openings on the first covering, as fluid may more rapidly penetrate into the inner chamber via such openings. As a result, a first portion of the fluid may arrive some fraction of second earlier at the inner chamber than the bulk of the fluid penetrating via the material of the first opening. This may lead to a pre-setting of the extractable product by the first portion of the fluid. Such pre-setting may result in improved taste characteristics, for example, strength of the prepared beverage. As a result, such pads may comprise less extractable product for providing the same strength of the beverage, which may be advantageous from a view point of mass production.

It will be appreciated that the first covering provided with openings as is described in the foregoing may be implemented either from the fiber-based non-woven material, or from any other suitable material, including conventional filter paper.

In a still further embodiment of the pad according to the invention the first covering comprises a foil in the said region, the openings being provided in the foil by perforation.

It is found to be advantageous to provide the first covering with a suitable foil, wherein the openings may be perforated, for example using a per se known method of cold needle perforation.

A container according to the invention comprises a plurality of pads as is described with reference to the foregoing.

In a particular embodiment of the container, each pad is provided with an individual wrapping, for example a foil or the like for improving taste preservation of the extractable product by the pad.

An apparatus according to a further aspect of the invention comprises a pad as is set forth in the foregoing, a receptacle for accommodating the pad and a fluid conduit having a first portion for conducting a pressurized fluid to the pad and a second portion for conducting the beverage away from the pad.

An apparatus according to the invention is preferably operable using a fluid having a supra-atmospheric pressure, for example in the range of 1 to 20 bars, preferably in the range of 1 to 2 bars.

A method of preparing a beverage according to a still further aspect of the invention comprises the steps of:
arranging a pad as is set forth in the foregoing in an apparatus comprising a receptacle for accommodating the pad and a fluid conduit having a first portion for conducting a pressurized fluid to the pad and a second portion for conducting the beverage away from the pad;
supplying the pressurized fluid via the first portion of the fluid conduit to the pad;
receiving the beverage in a vessel from the second portion of the conduit.

According to the invention the method of manufacturing a pad comprising an extractable product for preparing a beverage suitable for consumption, accommodated in an inner chamber between a first covering and a second covering, wherein the pad is conceived to be received in an apparatus arranged for preparing the beverage for intercepting a flow of fluid having supra-atmospheric pressure, comprises the steps of:
providing a first covering;
providing a second covering attached to the first covering;
providing the extractable product in the inner chamber formed between the first covering and the second covering, wherein the first covering is conceived to conduct the fluid into the inner chamber for interacting with the extractable product for preparing the beverage and the second covering is conceived to conduct the beverage away from the inner chamber, the method further comprising the step of
selecting for the first covering a partially transparent material for enabling visual inspection of the extractable product.

Preferably, the partially transparent material has at least 40% transparency to visible light. More preferably, the partially transparent material is at least 50% transparent to visible light, or even at least 70% transparent. Further advantageous embodiments of the method according to the invention comprise suitable steps for manufacturing the pad as is discussed with reference to the foregoing.

These and other aspects of the invention will be discussed in more detail with reference to drawings, wherein like reference numerals refer to like elements. It will be appreciated that the drawings are presents for illustrative purposes and may not be used for limiting the scope of the appended claims.

### BRIEF DESCRIPTION OF THE DRAWINGS

FIG. 1a presents in a schematic way an embodiment of a pad according to an aspect of the invention.

FIG. 1b presents in a schematic way a further embodiment of a pad according to a further aspect of the invention.

FIG. 2 presents in a schematic way a still further embodiment of a pad according to an aspect of the invention.

FIG. 3 presents in a schematic way a still further embodiment of a pad according to a still further aspect of the invention.

FIG. 4 presents in a schematic way a still further embodiment of a pad according to a still further aspect of the invention.

FIG. 5 presents in a schematic way a still further embodiment of a pad according to a still further aspect of the invention.

FIG. 6 presents in a schematic way an embodiment of a container according to a further aspect of the invention.

FIG. 7 presents in a schematic way an embodiment of an apparatus according to a further aspect of the invention.

FIG. 8 presents in a schematic way an embodiment of an experiment for measuring transparency of a covering sample.

### DETAILED DESCRIPTION OF THE DRAWINGS

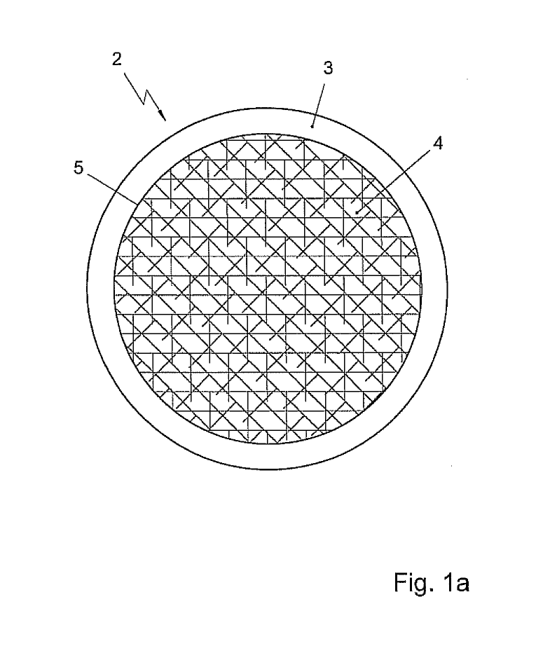

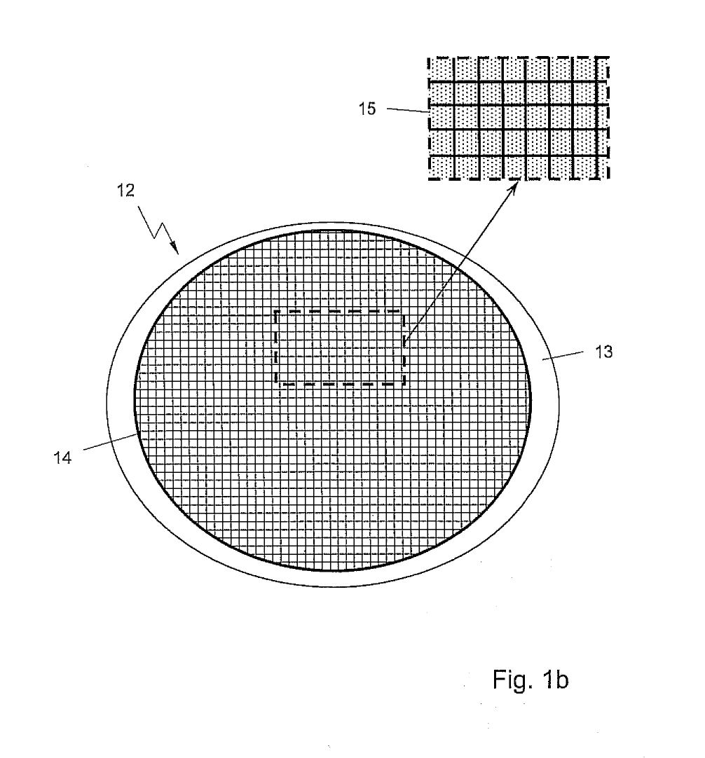

FIG. 1a presents in a schematic way an embodiment of a pad according to an aspect of the invention. FIG. 1a shows schematically a picture of a top view of a pad 2 according to the invention. The pad 2 may be used to accommodate ground coffee. The top view of the pad 2 shows a top covering 3, sealed to a bottom covering (not shown) by means of a sealing line 5. It will be appreciated that although the pad 2 is depicted as a circular structure, other geometries, like rectangular or square shapes are contemplated. The sealing line 5 is provided about a circumference of the pad 2, being suitably distanced from the outer edge of the top covering 3.

In accordance with an aspect of the invention, at least the top covering, i.e. a surface of the pad conceived to be viewed by the user upon handling of the pad, is manufactured from a fiber-based non-woven material. Fibers 4, may relate to lyocell fibers, pig hair, synthetic fibers, homogeneous or heterogeneous fibers, in particular two-component fibers, straw, nettle, flax, sisal or the like.

Preferably, density of the fiber-based non-woven material is about 18 g/m2 and a thickness of a fraction of a millimetre. As a result, a pad is provided, wherein at least one outer covering is transparent. Preferably, the top covering is transparent, as this surface is viewed by the user upon handling the pad. More preferably, the fiber-based non-woven material represents a surface by means of which a suitable fluid, like hot water or steam penetrates into an inner chamber of the pad wherein a suitable extractable product is accommodated.

FIG. 1b presents in a schematic way a further embodiment of a pad according to a further aspect of the invention. In the present embodiment a pad 12 is shown wherein at least the top covering 13 comprises a mesh. Preferably, for the mesh a nylon mesh is selected, as it is chemically inert under interaction with hot water and/or steam and is robust at least regarding application of external tension on the other hand. Detail 15, being an enlarged view of a portion of the pad 12, depicts schematically that the extractable product present inside the pad 12 may easily be viewed via the mesh of the top covering. The pad 12 may comprise a sealing line 14 which may also be provided along circumference of the pad 12.

It is found that the mesh may have an additional advantage as microscopic corpuscles of the extractable product may escape from an inner chamber of the pad prior to use. For example, if the pad 12 is used for accommodating ground coffee, tiny coffee particles may be found on an outer surface of the pad 12. As a result, a characteristic odour representative of the extractable product, such as coffee, is distributed in a region where the pad 12 dwells. This may be found advantageous, as such characteristic odour may provide an additional positive stimulus to a user handling the pad 12 leading to improved user's satisfaction regarding the pad 12.

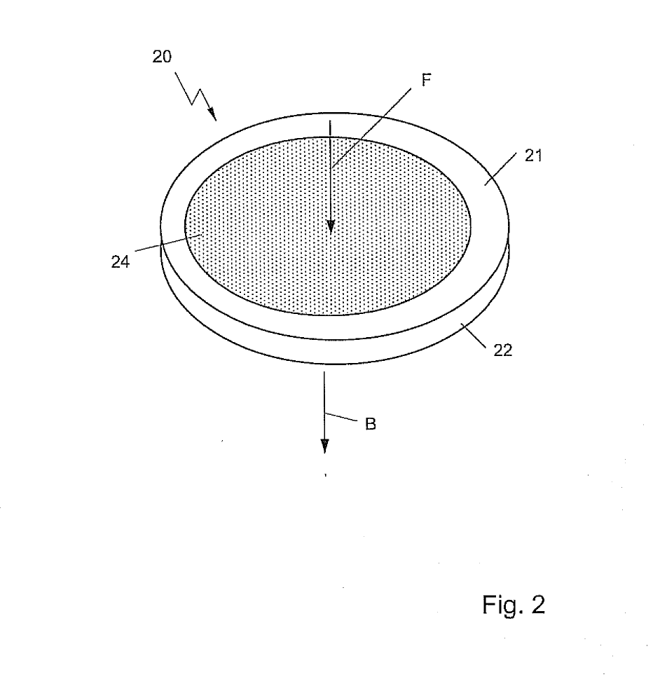

FIG. 2 presents in a schematic way a further embodiment of a pad according to a still further aspect of the invention. In the present embodiment a pad 20 is provided wherein at least a portion of a covering 21 is arranged with an additive 24 conceived to modify a chemical property or a chemical composition of the fluid F inflowing the pad 20. It will be appreciated that although the additive 24 is schematically illustrated as a continuous area on the covering 21, it is possible that the material of the covering 21 is impregnated with the additive, or is provided with a number is distinct areas, which may have the same or different additives. Among possible advantageous additives which can be provided on the covering 21 are the following: taste modifiers, pH modifiers, and/or scavengers. Taste modifier may relate to a similar substance, like dried coffee extract, or to a foreign substance, like sugar, milk, liqueur, aroma, or the like. The pH modifier may relate to either a base or an acid, preferably in dependence to a geographical area the pad 20 is being put on the market. As a result, quality of the extractable product, like coffee may be made independent of water quality present in different geographical areas. An embodiment of a suitable scavenger may relate to an anti-oxidant or a water scavenger, as it is found that by addition of such elements to the pad material preservation of the extractable product in the pad is improved.

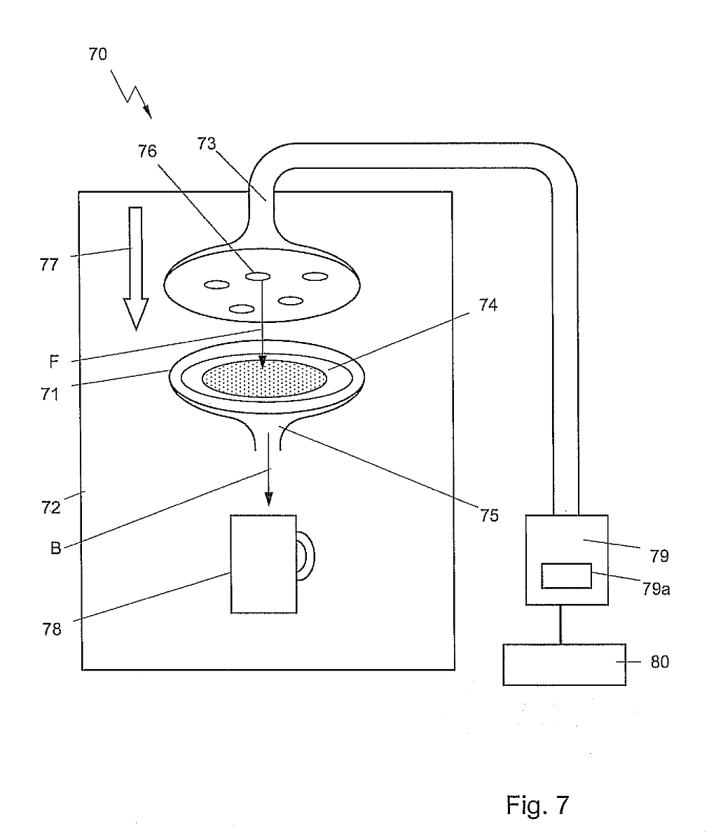

In use, the pad 20 is positioned in a suitable apparatus for preparing a beverage, for example, an apparatus as is discussed with reference to FIG. 7. A suitable fluid F, such as hot water or steam may interact with the additive 24 prior to flowing into the inner chamber of the pad (not shown). As a result, the chemical properties of the fluid may be modified prior to initiation of the extraction process, which may lead to improved quality of the beverage. Alternatively or additionally, the taste of the fluid may be modified prior to causing the fluid to interact with the extractable product.

It will be further appreciated that the additive 24 may be provided on one or both outer surfaces of the pad for sealing the inner chamber of the pad from environment. Such additive is conceived to be dissolved in the fluid F without having adverse effects regarding properties of the beverage.

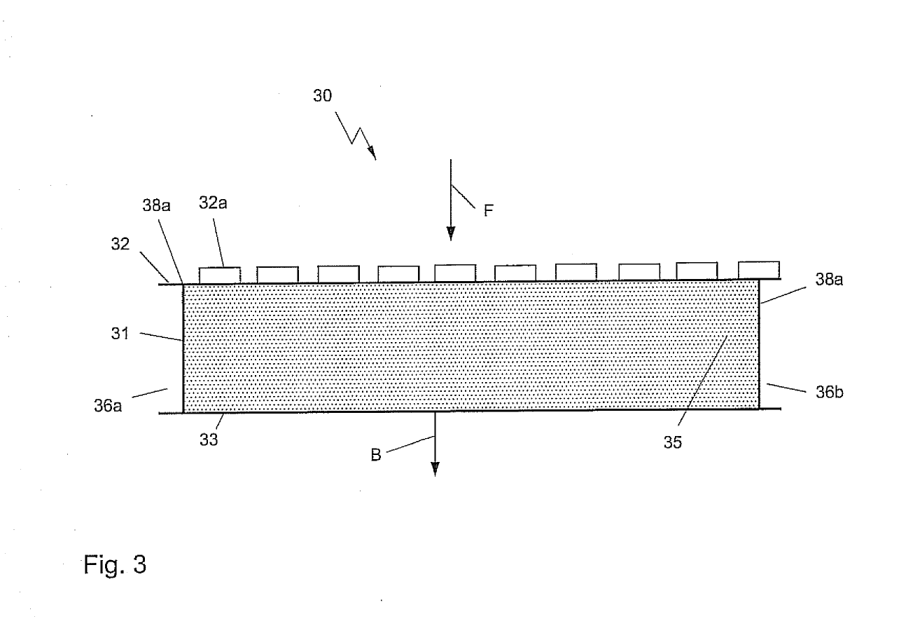

FIG. 3 presents in a schematic way a still further embodiment of a pad according to a still further aspect of the invention. In accordance with the present embodiment the pad 30, shown in a cross-section, comprises a first covering 32 provided with a modulated height profile showing protrusions 32a. The first covering 32 may relate to a top covering conceived to receive a fluid F for preparing the beverage using an extractable product accommodated in the inner chamber 35 of the pad 30. The bottom covering 33 may be implemented from a substantially flat filter paper or a substantially flat fiber-based non-woven material, or from any other suitable material capable of transporting a prepared beverage B away from the inner chamber 35 of the pad 30. The bottom covering 33 may be sealed to the upper covering 32 using a sealing line 38a, which may run along a circumference of the pad 30. It will be appreciated that areas 36a, 36b arranged at the periphery of the pad 30 may have a neglectably small dimension so that the top covering 32 abuts the bottom covering 33.

As a result of the height profile using the projections 32a, the user may experience the surface of the pad as being extremely soft, which may improve user satisfaction during handling of the pad.

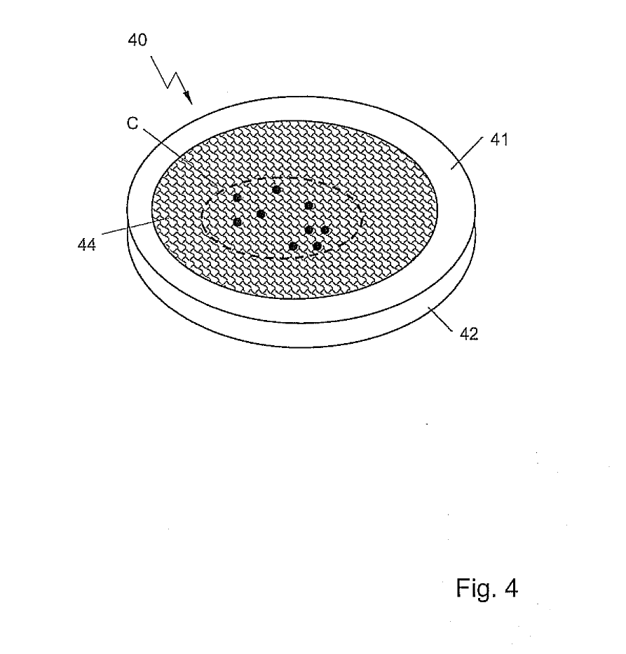

FIG. 4 presents in a schematic way a still further embodiment of a pad according to a still further aspect of the invention. In this particular embodiment the pad 40, is provided with microscopic pores 44, which may be homogeneously distributed along a surface of at least one of the first (top) covering 41 and the second (bottom) covering 42 of the pad 40. As a result microscopic particles C of an extractable product, such as coffee, accommodated in the internal chamber (not shown) of the pad may escape there from and may suitably dwell on an outer surface of the pad 40, for example on a top covering 41.

This has an effect that next to enabling the user with a possibility to visually percept the extractable product, further senses organs, like smell and touch, are stimulated when the user is handling the pad 40. For example, when the pad 40 comprises a ground coffee, the user may enjoy the view of the coffee and its smell already during handling the pad and not only after the beverage is prepared. As a result that user may enjoy preparing coffee to a higher extend than compared to the pads known from the art.

It will be appreciated that the term ‘pore’ should be broadly interpreted, as it relates not only to microscopic or measurable openings in the material of a covering, but may also relate to openings created in a woven structure, like a mesh. In addition, when the non-woven material is considered, the pores therein may correspond to thickness or density irregularities which enable the microscopic particle of the extractable product to escape from the inner chamber of the pad.

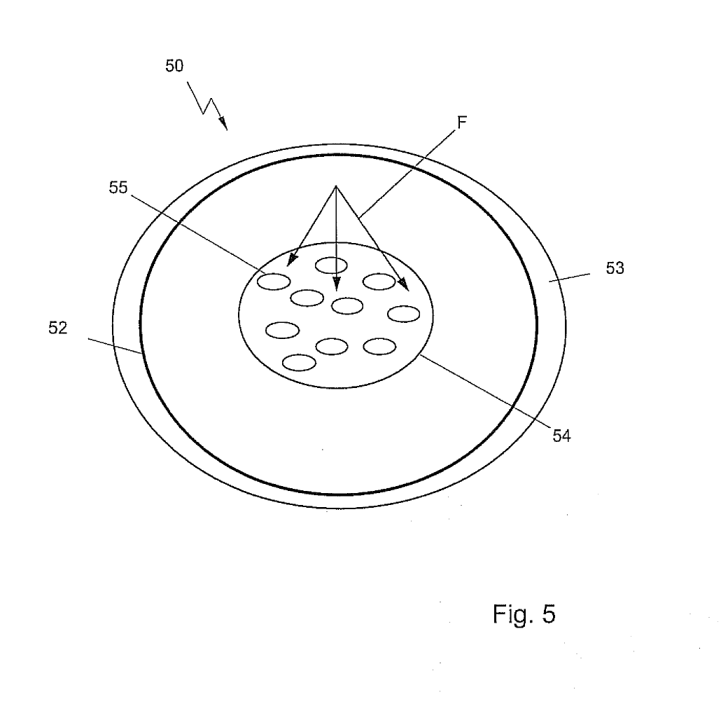

FIG. 5 presents in a schematic way a still further embodiment of a pad according to a still further aspect of the invention. In the present embodiment the pad 50 comprises a covering 53 which is provided with hydraulic openings 55, for enabling an accelerated penetration of a fluid into the inner chamber (not shown) of the pad. It will be appreciated that the openings are provided in a material of the covering conceived to receive a fluid F, which may be provided as a number of diverging flows or as a parallel flow or flows.

The pad 50 comprises top covering 53, which may be manufactured from any type of material suitable for accommodating an extractable product. For example, the covering 53 may relate to a conventional filter paper, for example, as known from US 2007/0071869. It is also possible that a centre portion 54 of the covering 53 is provided with a different material, for example with a foil, made of transparent plastic or a non-transparent metal foil. The openings 56 may be provided using a cold needle perforation.

Preferably, the material of the covering 53 enables a user to see the extractable product accommodated in the pad. In case when the material of the covering 53 comprises a fiber-based non-woven material, the openings 55 may be provided using a suitable perforation.

In case when the covering 53 is at least partially manufactured from a mesh or a woven structure, inter space between adjacent wires forming the mesh or the woven structure may be seen as embodiment of the openings.

The covering 53 may be suitably connected to a lower opening (not shown) using a sealing line 52. The sealing may relate to any possible method of connecting, comprising but not limited to melting or adhering. Depending on respective materials chosen for the first covering and the second covering, a method of their attachment to each other may be suitably selected.

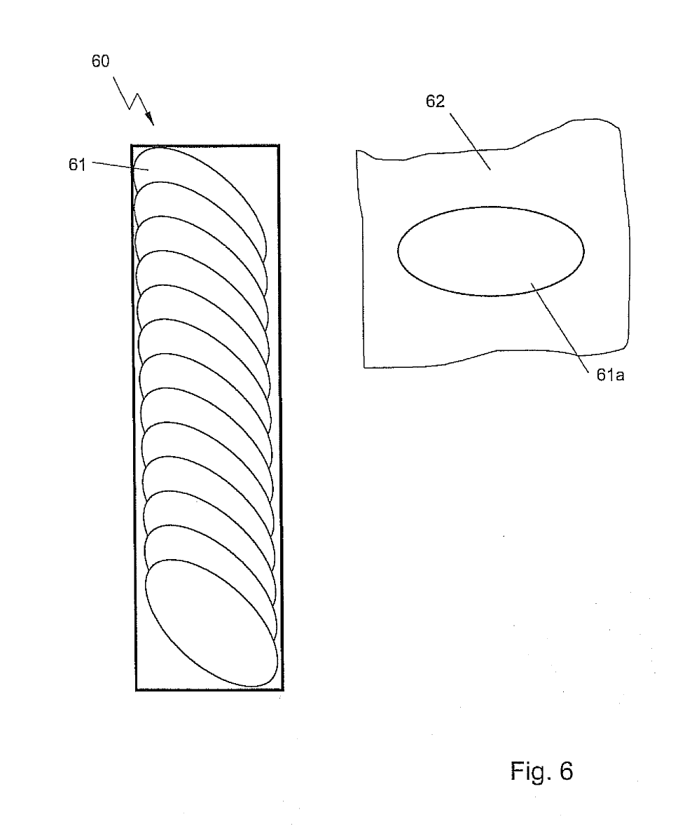

FIG. 6 presents in a schematic way an embodiment of a container according to a further aspect of the invention. The container 60, schematically depicted as a cylindrical tube, may comprise a suitable stack of individual pads 61 as is described in the foregoing. It will be appreciated that a pad may be arranged to accommodate about 7-8 g of the extractable product, for example ground coffee, which corresponds to a single cup. However, the pads may alternatively accommodate 3.5 g, of the extractable product, i.e. a half-portion, so that a user may select similar or different half-portions for preparing one portion of the beverage. As a result, when the pads are provided with different types of mutually compatible extractable product, the user may tune either strength or flavour of his beverage on demand. Such arrangement provides even more user satisfaction regarding a method of beverage production using a pad.

In a particular embodiment, each pad 61a, stored in the container 60 may be provided with individual packaging, which may still further prolong preservation of the extractable product in the pads 61 upon storage. It will be appreciated that different embodiments of the packaging may be envisaged. For example, the packaging may relate to a piece of foil 62 (shown in an unwrapped condition), or a suitable hermetically sealed pocket.

It will be appreciated that although a specific embodiment of the container 60 is depicted a great variety of solid or flexible containers may be envisaged.

FIG. 7 presents in a schematic way an embodiment of an apparatus according to a further aspect of the invention. The apparatus 70 may comprise a housing 72 accommodating at least a pad receptacle 71 arranged and constructed to receive a pad 74, as is discussed with reference to the foregoing. The housing 72 further comprises a fluid dispenser 73 being in fluid communication with a suitable fluid supply 79, for example an internal or an external reservoir (the latter is shown in FIG. 7). The fluid reservoir may be operable by a pressure unit 80 for causing the reservoir to provide a pressurized fluid into the fluid conduit and via the fluid dispenser 73 towards the pad 74. The reservoir may cooperate with a heater 79a for suitable heating water up to at least 95 degrees Celsius, or for preparing pressurized steam from water stored in the reservoir 79.

The fluid dispenser 73 may comprise one or more openings 76 for generating a flow of fluid F which is intercepted by the pad 74 for extracting an extractable product provided in the pad 74. Preferably, the fluid dispenser 77 is displaceably arranged and may be translated long the arrow 77 for substantially firmly pressing against an upper covering of the pad 74. The beverage B thus prepared in conducted away from the pad 74 using a further conduit 75. The apparatus 70 may comprise a suitable container 78 for collecting the beverage 78.

It will be appreciated that the apparatus 70 may be used for preparing a wide variety of beverages, including but not limited to coffee, tea, chocolate, cream coffee, cappuccino and the like.

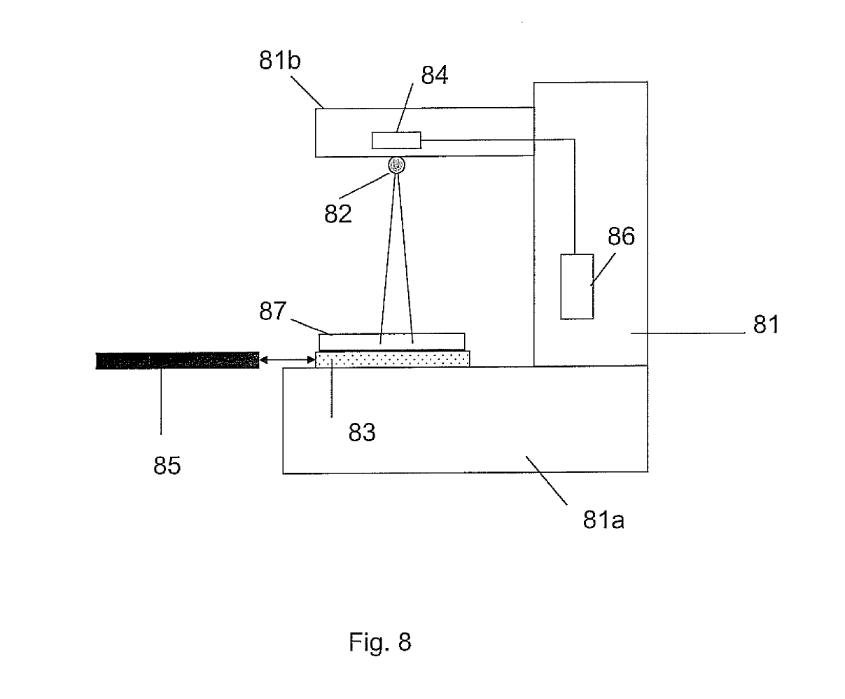

FIG. 8 presents in a schematic way an embodiment of an experiment for measuring transparency of a covering sample. Usually in a suitable experiment a photometer is used. Preferably, for a suitable photometer a standard BYK Gardner Spectrophotometer is used. An advantage of such a photometer is that it operates in an automated way. After specifying the illuminant, observer angle, and the reference color, the test sample may be inserted into a specimen holder of the said Spectrophotometer, and the spectrophotometer takes the reading. Three readings are usually taken and the results averaged. Typically a specimen size is about 50 mm or about 100 mm disk-shaped, although any flat sample that the specimen holder will grasp can be tested.

Usually, the BYK Gardner Spectrophotomer has an output related to Haze (%), Total Luminous Transmittance (%) and Diffuse Transmittance (%).

Haze can be inherent in the material, a result of its manufacturing method, or a result of surface texture. Haze can also be a result of environmental factors such as weathering or surface abrasion. Luminous Transmittance measures the amount of light that passes through a sample.

As an exemplary embodiment, a photometer 81 is shown, comprising a platform 81a arranged for accommodating a carousel with samples (not shown), whereon a white stage 83 may be provided. The photometer 18 further comprises an arm 81b accommodating a suitable source of white light 82 and, possibly, a collimator (not shown) arranged for shaping the emanating beam used for measuring transparency of a sample. Preferably, the beam from the source 82 has a cross-section of about 1 cm².

In order to measure transparency of a sample, like a first and/or a second covering, a suitable sample 87 is positioned on the white stage 83, after which light reflected from the sample 87 is measured by a suitable detector 84. Preferably, a signal from the detector 84 is supplied to a processing unit, calibrated and adapted to calculate a reflection coefficient (w) of the sample 87 on the white stage 83.

After the white stage is replaced with the black stage 85, the experiment is repeated and the processing unit 86 calculates a reflection coefficient (s) of the sample on the black stage. These two values enable calculation of transparency of the sample.

Additionally, when respective reflection coefficients of the black and white stages are known, transparency Θ of the sample 87 may be calculated as follows:

$$Θ = 100 \sqrt{\frac{w - s}{{U}_{w} - {U}_{s}}} [ \% ]$$

wherein Uw is a reflection coefficient of the white stage and Us is a reflection coefficient of a black stage.

It will be appreciated that a different analytical model may be used in the BYK Gardner Spectrophotomer for generating an output related to Haze (%), Total Luminous Transmittance (%) and Diffuse Transmittance (%). It will be further appreciated that while specific embodiments of the invention have been described above, that the invention may be practiced otherwise than as described. In addition, isolated features discussed with reference to different figures may be combined.

1. A pad comprising an extractable product for preparing a beverage suitable for consumption, said pad comprising:
a first covering,
a second covering attached to the first covering,
an inner chamber formed between the first covering and the second covering for accommodating the extractable product,
wherein the pad is received in an apparatus arranged for preparing the beverage for intercepting a flow of fluid having supra-atmospheric pressure,
wherein the first covering conducts the fluid into the inner chamber for interacting with the extractable product for preparing the beverage and the second covering conducts the beverage away from the inner chamber, said first covering comprising a partially transparent material for enabling visual inspection of the extractable product.

2. The pad according to claim 1, wherein the partially transparent material has at least 10%, 20%, 30%, 40%, 50%, 70% or 90% transparency to visible light.

3. The pad according to claim 1, wherein the partially transparent material is a mesh, preferably a nylon mesh.

4. The pad according to claim 1, wherein the partially transparent material is a fiber-based or continuous filament based non-woven material.

5. The pad according to claim 4, wherein the fiber-based comprises two-component fibers.

6. The pad according to claim 4, wherein the fiber-based non-woven material comprises about 20% of cellulose.

7. The pad according to claim 4, wherein the second covering comprises a fiber-based material.

8. The pad according to claim 7, wherein the second covering comprises substantially the same fiber-based material as the first covering.

9. The pad according to claim 4, wherein the fibers of the fiber-based non-woven material are non-bleached.

10. The pad according to claim 1, wherein the first covering and/or the second covering comprise an additive.

11. The pad according to claim 10, wherein the additive is arranged to seal the inner chamber from environment.

12. The pad according to claim 10, wherein the additive is arranged for altering a chemical property of the fluid or the beverage.

13. The pad according to claim 12, wherein the additive is selectable from a group consisting of a taste modifier, a pH modifier, a scavenger.

14. The pad according to claim 4, wherein an outer surface of at least one of the first covering and the second covering comprises a pre-determined height profile.

15. The pad according to claim 1, wherein material of at least one of the first covering and the second covering comprises an area capable of transporting microscopic amounts of the extractable product outside the inner chamber before use.

16. The pad according to claim 15, wherein the said material comprises micro-pores substantially homogeneously distributed over a surface area of the material.

17. The pad according to claim 1, wherein at least one of the first covering and the second covering is biodegradable.

18. The pad according to claim 17, wherein the first covering and/or the second covering is at least partially manufactured from a renewable resource.

19. The pad according to claim 18, wherein the renewable resource comprises polyethylene obtained from corn.

20. The pad according to claim 1, wherein the first covering comprises pre-manufactured openings provided in a region conceived to intercept the fluid in use.

21. The pad according to claim 20, wherein the first covering comprises a foil in the said region, the openings being provided in the foil by perforation.

22. The pad according to claim 1, wherein transparency of the first covering is at least 10% higher than transparency of the second covering.

23. The container comprising a plurality of pads according to claim 1.

24. An apparatus for preparing a beverage from an extractable product, the apparatus comprising a pad according to claim 1, a receptacle for accommodating the pad and a fluid conduit having a first portion for conducting a pressurized fluid to the pad and a second portion for conducting the beverage away from the pad.

25. A method of preparing a beverage comprising the steps of:
arranging a pad in an apparatus comprising a receptacle for accommodating the pad and a fluid conduit having a first portion for conducting a pressurized fluid to the pad and a second portion for conducting the beverage away from the pad, the pad comprising a first covering, a second covering attached to the first covering, an inner chamber formed between the first covering and the second covering for accommodating the extractable product, wherein the first covering conducts the fluid into the inner chamber for interacting with the extractable product for preparing the beverage and the second covering conducts the beverage away from the inner chamber, said first covering comprising a partially transparent material for enabling visual inspection of the extractable product;
supplying the pressurized fluid via the first portion of the fluid conduit to the pad;
receiving the beverage in a vessel from the second portion of the conduit.

26. The method according to claim 25, wherein pressure of the pressurize fluid is in the range of 1 to 20 bars, preferably 1 to 2 bars.

27. A method of manufacturing a pad comprising an extractable product for preparing a beverage suitable for consumption accommodated in an inner chamber between a first covering and a second covering, wherein the pad is conceived to be received in an apparatus arranged for preparing the beverage for intercepting a flow of fluid having supra-atmospheric pressure, the method comprising the steps of:
providing a first covering;
providing a second covering attached to the first covering;
providing the extractable product in the inner chamber formed between the first covering and the second covering, wherein the first covering is conceived to conduct the fluid into the inner chamber for interacting with the extractable product for preparing the beverage and the second covering is conceived to conduct the beverage away from the inner chamber;
selecting for the first covering to be a partially transparent material for enabling visual inspection of the extractable product.
